(19) United States
(12) Patent Application Publication
(10) Pub. No.: US 2013/0261946 A1
(43) Pub. Date: Oct. 3, 2013

(54) VEHICLE INFORMATION MANAGEMENT SERVER, VEHICLE INFORMATION MANAGEMENT SYSTEM, AND VEHICLE INFORMATION MANAGEMENT METHOD

(71) Applicants: Koji Sengoku, Tokyo (JP); Tadafumi Nogawa, Tokyo (JP); Kazuya Tamura, Tokyo (JP)

(72) Inventors: Koji Sengoku, Tokyo (JP); Tadafumi Nogawa, Tokyo (JP); Kazuya Tamura, Tokyo (JP)

(73) Assignee: HONDA MOTOR CO., LTD., Tokyo (JP)

(21) Appl. No.: 13/991,562

(22) PCT Filed: Oct. 27, 2011
(86) PCT No.: PCT/JP2011/074790

§ 371 Date: Jun. 4, 2013

(30) Foreign Application Priority Data
Dec. 7, 2010 (JP) 2010-272412

(51) Int. Cl. G06F 17/00

(52) U.S. Cl. CPC G06F 17/00
USPC 701/123

(57) ABSTRACT

Provided is a system or the like which is able to achieve suitable improvement of usability of information provided to the driver of each vehicle in view of the environment in which the vehicle is travelling. The system or the like enables to make the driver of each vehicle aware of reference driving information according to a driving index value of a reference vehicle which is extracted based on a standard value from a plurality of vehicles. It is thus possible to make the driver aware of a correlation between the standard value and the reference driving index value, and use it as reference when driving the vehicle himself/herself. The standard value is set fluidly according to the actual fuel consumption or electric power consumption of each vehicle.

### TECHNICAL FIELD

The present invention relates to a server for managing vehicle information such as fuel consumption or the like, and a system having the server as its element.

### BACKGROUND ART

There has been an increasing demand for information which is useful for improving or lowering fuel consumption. A technical approach of analyzing a driving habit of a vehicle from a view point of improving fuel consumption, and providing an improvement plan of the driving habit to a driver has been proposed (Patent Document 1). According to the approach, appropriateness in view of fuel consumption is determined, for example, according to whether or not a vehicle speed is above a reference value.

### PRIOR ART DOCUMENTS

### Patent Document

Patent Document 1: Japanese Patent Laid-Open Publication No. 2003-016572

### SUMMARY OF INVENTION

### Problems to be solved by the Invention

However, in a case the reference value for determining appropriateness of the driving habit of the vehicle from the view point of fuel consumption or power consumption (hereinafter referred to as “fuel consumption or the like”, as appropriate), there is a possibility that the driving habit is determined to be inappropriate due to unavoidable degradation of fuel consumption or the like derived from a travelling environment such as traffic congestion or an ascending slope or the like.

It is therefore an object of the present invention to provide a system or the like which is able to achieve suitable improvement of usability of information provided to the driver of each vehicle in view of the environment in which the vehicle is travelling.

### Means for solving the Problem

To solve the problem described above, the present invention provides a vehicle information management server comprising: a first support arithmetic processing element configured to recognize a driving index value as an index of a driving manner and a fuel consumption or a power consumption of each of vehicles, based on communications with each of the vehicles, and then to recognize a standard value as a criteria for determining a level of the fuel consumption or power consumption of each of the vehicles according to the fuel consumption or power consumption of each of the vehicles; and a second support arithmetic processing element configured to recognize a reference driving index value based on the driving index value of one or a plurality of reference vehicles extracted among the vehicles based on the standard value recognized by the first support arithmetic processing element, and then to make a predetermined information processing terminal device recognize and output a reference driving information related to the reference driving index value based on communication with the predetermined information processing terminal device.

To solve the problem described above, the present invention provides a vehicle information management system including a vehicle information management device installed in a vehicle and the vehicle information management server, wherein the vehicle information management device is configured to make the first support arithmetic processing element recognize the driving index value based on communication with the vehicle information management server.

To solve the problem described above, the present invention provides a vehicle information management method which is a method performed by a computer, comprising: an arithmetic processing for recognizing a driving index value as an index of a driving manner and a fuel consumption or a power consumption of each of vehicles, based on communications with each of the vehicles; an arithmetic processing for recognizing a standard value as a criteria for determining a level of the fuel consumption or power consumption of each of the vehicles according to the fuel consumption or power consumption each of the vehicles; an arithmetic processing for recognizing a reference driving index value based on the driving index value of one or a plurality of reference vehicles extracted among the vehicles based on the standard value; and an arithmetic processing for making a predetermined information processing terminal device recognize and output a reference driving information related to the reference driving index value, based on communication with the predetermined information processing terminal device.

According to each of the vehicle information management server, the vehicle information management system, and the vehicle information management method of the present invention, it is able to make the driver of each vehicle recognize the reference driving information according to the driving index value of the reference vehicle extracted among the plurality of vehicles based on the standard value. By doing so, it is able to make the driver recognize a correlation between the standard value and the reference driving index value and use it as reference when driving the vehicle himself/herself. Even for the same vehicle, if the fuel consumption or the like and the travelling period differ, the vehicle can be assumed as a plurality of vehicles.

The “standard value” is set fluidly according to the actual fuel consumption or the like of each vehicle. Therefore, a situation in which the standard value, and thus the reference driving index value, is set to a value deviated from a travelling environment of each vehicle can be avoided. As a result, the improvement of usability of the reference driving information is attained.

Here, an element of the present invention “recognizes” an information means to execute all kinds of information processing in order to prepare the information for other information processing such as the element receiving the information, search or reading out the information from a database or a memory, arithmetic processing based on basic information received or the like to calculate, estimate, set, determine, search or the like the information, actualizing the information by decoding the packet, furthermore, storing the information calculated or the like in the memory, or the like.

Furthermore, an element of the present invention “outputs” an information means to output the information by displaying, audio output, vibration output or the like, that is, by all kinds of forms that a human being can recognize through their senses like eyesight, hearing, touch, or the like.

The first support arithmetic processing element may be configured to recognize separately each of a different travelling states of each of the vehicles based on communication with each of the vehicles, and then to recognize the standard value for each of the different travelling states, and the second support arithmetic processing element may be configured to recognize the reference driving index value for each of the different travelling states and to make the predetermined information processing terminal device recognize the reference driving index value.

According to the vehicle information management server having the above configuration, it is able to make the driver recognize a correlation between the standard value and the reference driving index value for each of the different travelling condition of the vehicle, and use it as reference when driving the vehicle himself/herself.

The first support arithmetic processing element may be configured to recognize as the standard value for a certain vehicle, an average fuel consumption or an average power consumption of the vehicles, or an average fuel consumption or an average power consumption of one vehicle group in which the certain vehicle belongs or of another vehicle group which is adjacent to the one vehicle group at a high fuel consumption side or a high power consumption side, or at a low fuel consumption side or a low power consumption side, among a plurality of vehicle groups defined by sectioning the vehicles according to a level of the fuel consumption or the power consumption.

The second support arithmetic processing element may be configured to make the predetermined information processing terminal device to recognize and output, for a certain vehicle, the reference driving information related to the driving index value recognized by the first support arithmetic processing element in addition to the reference driving index value.

According to the vehicle information management server of the above configuration, it is able to make the driver recognize a correlation between the fuel consumption or the like and the driving index value of the vehicle driven by himself/herself, in addition to the correlation between the standard value and the reference driving index value. By doing so, it is able to make the driver recognize, when driving the vehicle himself/herself, how the driving index value should be adjusted in view of the reference driving index value in order to bring the fuel consumption or the like of the vehicle close to the standard value or away from the standard value.

The first support arithmetic processing element may be configured to recognize a position of the vehicle in time series in each cycle based on communication with the vehicle, and then to recognize a speed and acceleration-deceleration of the vehicle as the driving index value in the each cycle, based on the position of the vehicle in time series in each cycle.

### BRIEF DESCRIPTION OF THE DRAWINGS

FIG. 1 is a diagram illustrating a configuration of a vehicle information management system of the present invention;

FIG. 2 is a functional explanatory diagram of the vehicle information management system of the present invention;

FIG. 3A is an explanatory diagram related to a vehicle extracting method according to a standard fuel consumption, and FIG. 3B is an explanatory diagram related to another vehicle extracting method according to the standard fuel consumption;

FIG. 4A is a first explanatory diagram related to reference driving information, and FIG. 4B is also a first explanatory diagram related to another reference driving information; and

FIG. 5A is a second explanatory diagram related to reference driving information, FIG. 5B is also a second explanatory diagram related to another reference driving information, and FIG. 5C is also a second explanatory diagram related to another reference driving information.

### DESCRIPTION OF EMBODIMENTS

(Configuration of a Vehicle Information Management System)

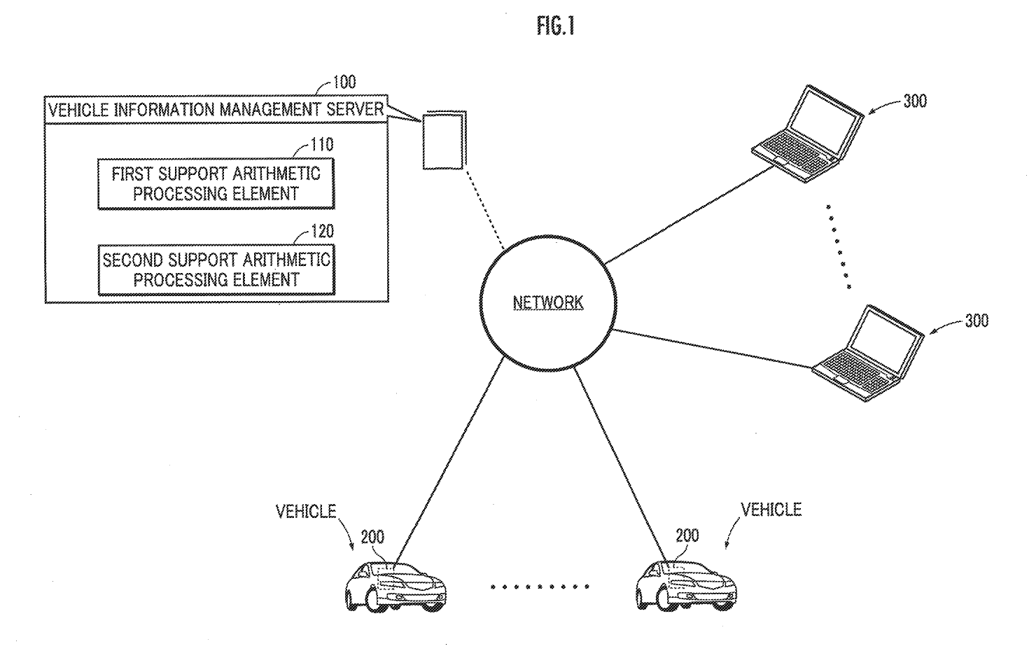

The vehicle information management system illustrated in FIG. 1 is configured to have a vehicle information management server 100 and a vehicle information management device 200 mounted in an automotive vehicle 2. It is acceptable that a part of or the entire part of the vehicle information management device 200 is constituted from a portable apparatus which may be detached from the vehicle and carried.

The vehicle information management server 100 has communication functions with the vehicle information management device 200 and other information processing terminal devices 300 respectively via network, and is composed of a single or plural server computers. As the communication network, an internet, a phone-line network or a communication network using satellite broadcast may be used. The network for establishing communication between the vehicle information management server 100 and the vehicle information management device 200 and the network for establishing communication between the vehicle information management server 100 and the information processing terminal devices 300, may be same or may be different.

The vehicle information management server 100 is provided with a first support arithmetic processing element 110 and a second support arithmetic processing element 120. Each of the first support arithmetic processing element 110 and the second support arithmetic processing element 120 is composed of a software (vehicle information management program) downloaded or installed to the vehicle information management server 100, and a hardware such as a memory for storing the software and a CPU (central processing unit) or the like for executing a predetermined arithmetic processing by reading out the software from the memory. It is acceptable that the first support arithmetic processing element 110 and the second support arithmetic processing element 120 are configured from partially or completely physically different hardware resources.

The first support arithmetic processing element 110 is configured to recognize a driving index value as an index of a driving manner and a fuel consumption of each vehicle according to communications with each of a plurality of vehicles. The first support arithmetic processing element 110 is configured to recognize a standard value which is a criterion for determining the level (high-low) of the fuel consumption of each vehicle according to the fuel consumption of each of the plurality of vehicles.

The second support arithmetic processing element 120 is configured to recognize a reference driving index value based on a driving index value of one or a plurality of reference vehicles extracted from the plurality of vehicles based on the standard value recognized by the first support arithmetic processing element 110. Based on communication with a predetermined information processing terminal device 300, the second support arithmetic processing element 120 is configured to make the information processing terminal device 300 recognize and output reference driving information related to the reference driving index value.

Here, in addition to portable terminal devices or personal computers different from the vehicle information management device 200, the vehicle information management device 200 itself may be the information processing terminal device 300.

The vehicle information management device 200 is configured to measure a position of the vehicle in time-series and an accumulated fuel consumption amount based on output signals and the like from various sensors mounted in the vehicle, and to transmit travelling information including the measurement result to the vehicle information management server 100.

In the case where the vehicle information management device 200 is the information processing terminal device 300, it may be configured that upon receiving the reference driving information distributed from the vehicle information management server 100, an output device is made to output the reference driving information to a display device or the like disposed in a center console or the like of the vehicle 2.

(Functions of the Vehicle Information Management System)

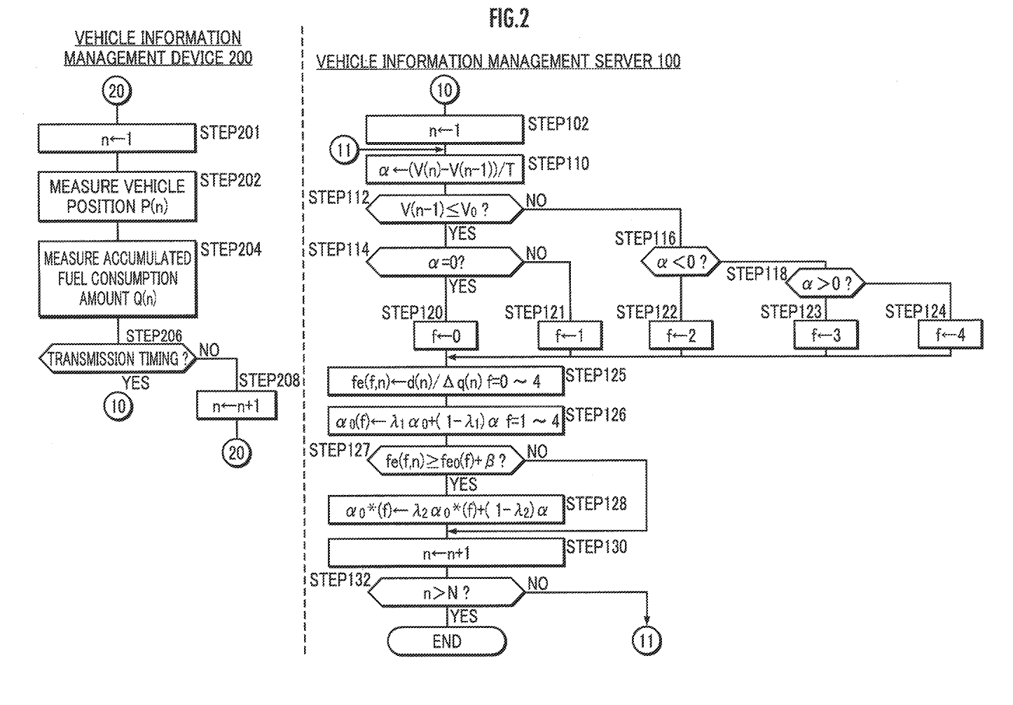

In the vehicle information management device 200, an index n is reset to “1” in response to a switching of an IGN switch or an ACC switch of the vehicle from OFF to ON, or the like (FIG. 2/STEP 201).

The vehicle position p(n) is measured according to an output of a gyro sensor if necessary, in addition to signals received by a GPS receiver mounted in the vehicle (FIG. 2/STEP 202). The vehicle position p(n) may be denoted by two dimensional coordinate values (latitude and longitude) or may be denoted by three dimensional coordinate values (latitude, longitude and altitude).

Furthermore, the accumulated fuel consumption amount Q(n) of the vehicle is measured (FIG. 2/STEP 204).

Then, it is determined whether or not it has become the transmitting timing of the travelling information including the vehicle position p(n) and the accumulated fuel consumption amount Q(n) (FIG. 2/STEP 206). Whether or not it is the transmitting timing is determined based on, for example, whether or not a measurement time by a timer has become an integral multiple of a transmission period, whether or not a travelling distance of the vehicle has become an integral multiple of a designated distance, whether or not the vehicle position has reached a node of an intersection or the like. The travelling information corresponds to probe information or floating car data (FCD) in a sense that it includes the vehicle position p(n) in time series.

In a case it is determined that it has not reached the transmitting timing (FIG. 2/STEP 206 . . . NO), the index n is increased by “1” (FIG. 2/STEP 208), and the arithmetic processing is repeated (FIG. 2/STEP 201 to STEP 206).

On the other hand, in a case it is determined that it has reached the transmitting timing (FIG. 2/STEP 206 . . . YES), travelling information is transmitted to the vehicle information management server 100 from the vehicle information management device 200. A vehicle identifier for identifying the vehicle such as VIN or the like is included in the travelling information. The travelling information may also include a measurement time of the vehicle position p(n) in addition to a personal identifier such as an user ID or the like for identifying a driver of the vehicle.

The sequence of the arithmetic processing by the vehicle information management device 200 is repeatedly performed during one operation period which starts from switching the IGN switch or the ACC switch from OFF to ON until switching the same from ON to OFF.

At the vehicle information management server 100, the following arithmetic processing is performed according to the travelling information for each vehicle identified by the vehicle identifier.

First, among the travelling information, the index n denoting the measurement value to be calculated is reset to 1 (FIG. 2/STEP 102).

A vehicle acceleration α={v(n)−v(n−1)}/T is calculated by the first support arithmetic processing element 110 (FIG. 2/STEP 110). The acceleration α corresponds to the “driving index value”. “T” means a period of the sequence of the arithmetic processing including determination of vehicle position p(n) (refer to FIG. 2/STEP 202) and the measurement of accumulated fuel consumption amount Q(n) (refer to FIG. 2/STEP 204) at the vehicle information management device 200. The vehicle speed v(n) is obtained by dividing the travelling distance d(n) from a previous vehicle position p(n−1) to a current vehicle position p(n) during the time n−1 to the time n by the period T.

It is determined whether or not the previous vehicle speed v(n−1) was a predetermined speed v₀ or less (FIG. 2/STEP 112). This determination corresponds to a determination of whether or not the vehicle at the previous time n−1 was stopped.

In a case where it is determined that the previous vehicle speed v(n−1) was the predetermined speed v₀ or less (FIG. 2/STEP 112 . . . YES), it is further determined whether or not the acceleration α is zero (FIG. 2/STEP 114). If it is determined that the acceleration α is zero (FIG. 2/STEP 114 . . . YES), a flag f expressing the travelling state of the vehicle is set to “0” which indicates an “idling state” (FIG. 2/STEP 120). If it is determined that the acceleration α is not zero (a positive value) (FIG. 2/STEP 114 . . . NO), the flag f is set to “1” which indicates a “start acceleration state” (FIG. 2/STEP 121).

Furthermore, in a case where it is determined that the previous vehicle speed v(n−1) was more than the predetermined speed v₀, (FIG. 2/STEP 112 . . . NO), it is determined whether or not the acceleration α is negative (FIG. 2/STEP 116). Moreover, if it is determined that the acceleration α is not negative (FIG. 2/STEP 116 . . . NO). it is determined whether or not the acceleration α is positive (FIG. 2/STEP 118).

In a case where it is determined that the vehicle acceleration α is negative (FIG. 2/STEP 116 . . . YES), the flag f is set to “2” which indicates a “deceleration state” (FIG. 2/STEP 122). In a cases where it is determined that the vehicle acceleration α is positive (FIG. 2/STEP 118 . . . YES), the flag f is set to “3” which indicates an “acceleration state” (FIG. 2/STEP 123). In a case where it is determined that the vehicle acceleration α is zero (FIG. 2/STEP 118 . . . NO), the flag f is set to “4” which indicates a “constant-speed cruising state” (FIG. 2/STEP 124).

The fuel consumption fe(f, n)=d(n)/Δq(n) is calculated for any one of the pertinent value among flag f=0 to 4 by the first support arithmetic processing element 110 (FIG. 2/STEP 125). Here, Δq(n)=q(n)−q(n−1) and q(n)=Q(n)−Q(n−1).

“Fuel consumption” means a travelling distance of the vehicle per consumption amount unit of the fuel. In this case, the fuel consumption is “good” as the fuel consumption is higher, and the fuel consumption is “bad” as the fuel consumption is lower. Contrary to this, the fuel consumption may mean a fuel consumption amount per travel distance unit. In this case, the fuel consumption is “good” as the fuel consumption is lower and the fuel consumption is “bad” as the fuel consumption is higher. The fuel is a concept encompassing fuel gas such as hydrogen or the like for fuel cell vehicles, in addition to carbon fuel such as gasoline or the like.

The first support arithmetic processing element 110 calculates an average fuel consumption fe(f) per unit term such as one day, one week, or one month or the like for each different travelling state based on the fuel consumption fe(f, n) calculated as described above, for each vehicle. Similarly, an average acceleration per unit term is calculated for each different travelling state based on the acceleration α calculated as described above, for each vehicle.

Moreover, the first support arithmetic processing element 110 calculates a standard value fe₀(f) for each travelling state of the plurality of vehicles based on the average fuel consumption fe(f) per unit term of each vehicle. For example, the average fuel consumption per unit term of the plurality of vehicles are calculated as the standard value fe₀(f). The average acceleration α₀(f) per unit term for each travelling state of the plurality of vehicles are calculated based on the average acceleration per unit term of each vehicle.

The second support arithmetic processing element 120 extracts or selects a “reference vehicle” among the plurality of vehicles based on the standard value.

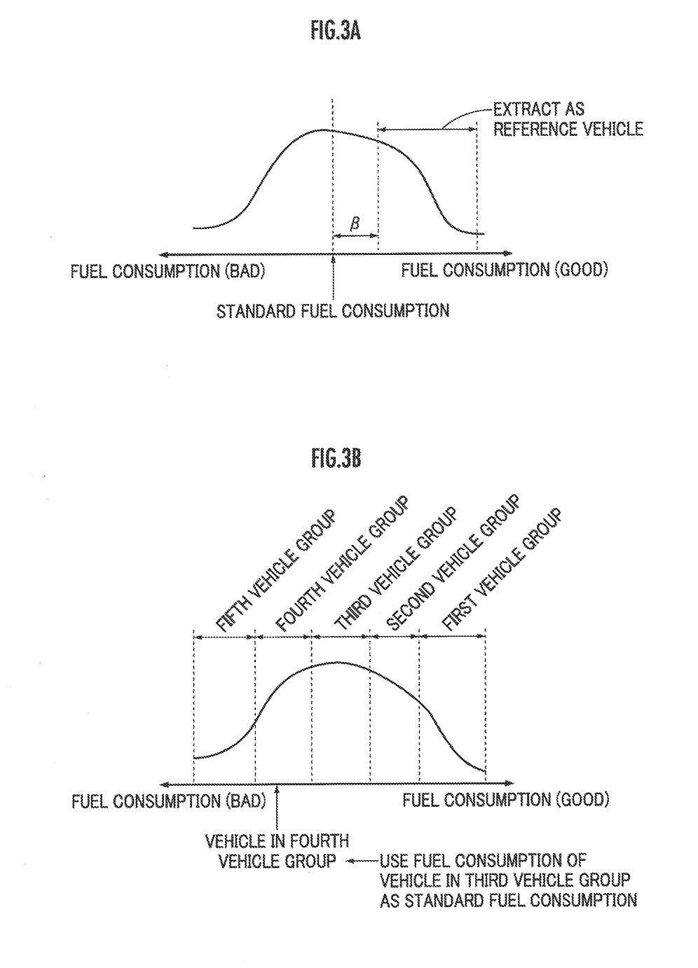

For example, as is illustrated in FIG. 3A, in a case where fuel consumption histogram of a plurality of vehicles for a certain travelling state is shown, a vehicle having a fuel consumption equal to or more than a value in which a positive value β is added to the standard value fe₀(f), is extracted as the reference vehicle.

Moreover, as is illustrated in FIG. 3B, it is acceptable that a plurality of vehicles are divided into a plurality of vehicle groups (for example 5) based on the appropriateness of the fuel consumption, and as for the vehicles belonging to the k-th vehicle group (k=2 to 5), a representative value of fuel consumption such as average fuel consumption, lowest fuel consumption or highest fuel consumption or the like of vehicles belonging to (k−1)-th vehicle group on the higher fuel consumption side, is calculated as the standard value, and a vehicle indicating a fuel consumption of the standard value or more may be extracted as the reference vehicle. Furthermore, as for a vehicle belonging to the k-th vehicle group (k=2 to 5), it is acceptable that a representative value of the fuel consumption of the vehicle belonging to the k-th vehicle group is calculated as the standard value, and a vehicle indicating a fuel consumption equal to or more than a value in which a positive value β is added to the standard value, may be extracted as the reference vehicle.

As for a vehicle belonging to the k-th vehicle group (k=1 to 4), it is acceptable that a representative value of fuel consumption of vehicles belonging to (k+1)-th vehicle group on the lower fuel consumption side, is calculated as the standard value, and a vehicle indicating a fuel consumption of the standard value or more may be extracted as the reference vehicle.

The second support arithmetic processing element 120 calculates, as for the concerned value among flag f=1 to 4, a new average acceleration α₀(f) of a plurality of vehicles including the vehicle according to the relational expression (1) based on the former average acceleration α₀(f) of the plurality of vehicles (there are cases where the vehicle in concern is not included) and the acceleration α of the vehicle (FIG. 2/STEP 126).

New α₀(f)=λ₁×former α₀(f)+(1−λ₁)×α relational expression (1)

Here, “λ₁” is a positive value less than 1, and for example, 0.5 or a value close to 0.5 (0.55, 0.48 or the like) is used as this value.

It is determined whether or not the fuel consumption fe(f, n) of travelling state f is equal to or more than a value in which a positive value β is added to the standard value fe₀(f) of the travelling state expressed by flag f (FIG. 2/STEP 127). This determination corresponds to determining whether or not the fuel consumption fe(f, n) of the vehicle is superior among the plurality of vehicles.

In a case where the determination result is positive (FIG. 2/STEP 127 . . . YES), a new reference acceleration α₀*(f) (reference index value) is calculated according to relational expression (2) based on the former reference acceleration α₀*(f) of the reference vehicle extracted from the plurality of vehicles and the acceleration α of the vehicle (FIG. 2/STEP 128).

New α₀*(f)=λ₂×former α₀*(f)+(1−λ₂)×α relational expression (2)

Here, “λ₂” is a positive value less than 1, and for example, 0.5 or a value close to 0.5 (0.52, 0.46 or the like) is used as this value.

Thereafter, the index n is increased by “1” (FIG. 2/STEP 130). In a cases where the determination result is negative (FIG. 2/STEP 127 . . . NO), the reference acceleration α₀*(f) is not updated and the index n is increased only by “1” (FIG. 2/STEP 130).

Then, it is determined whether or not the index n is more than a number N of combinations of the vehicle position p(n) and the accumulated fuel consumption amount Q(n) included in the travelling information (FIG. 2/STEP 132). The number N coincides with an integral portion of a quotient of dividing the transmission period of the travelling information by the arithmetic processing period of the vehicle information management device 200 (refer to FIG. 2/STEP 202 to STEP 206). In a case where the determination result is negative (FIG. 2/STEP 132 . . . NO), the sequence of processing after the calculation of the acceleration α is executed repeatedly (refer to FIG. 2/STEP 110 to STEP 130). In a case where the determination result is affirmative (FIG. 2/STEP 132 . . . YES), the sequence of processing regarding the travelling information is terminated.

Furthermore, based on the communication with the information processing terminal device 300 by the second support arithmetic processing element 120, “reference driving information” related to the reference acceleration α₀*(f) (reference driving index value) is recognized by the information processing terminal device 300. In addition to the reference acceleration α₀*(f), average fuel consumption per unit term of each vehicle, average acceleration α₀(f) per unit term of a plurality of vehicles, and average fuel consumption and average acceleration α₀(f) per unit term of each vehicle, may be included in the reference driving information. The reference driving information may be generated in the vehicle information management server 100 based on basic information such as reference acceleration α₀*(f) or the like, and also may be generated by the information processing terminal device 300 which received the basic information from the vehicle information management server 100.

For example, the reference driving information is transmitted to the information processing terminal device 300 by the user as the driver or owner of the vehicle mounted with the vehicle information management device 200 logs in to a predetermined site on the network through the information processing terminal device 300. As the identifier used for log in, vehicle identification number or personal identification number to identify the vehicle to be browsed, or a user ID tagged to these identification numbers and managed by the vehicle information management server 100, are used.

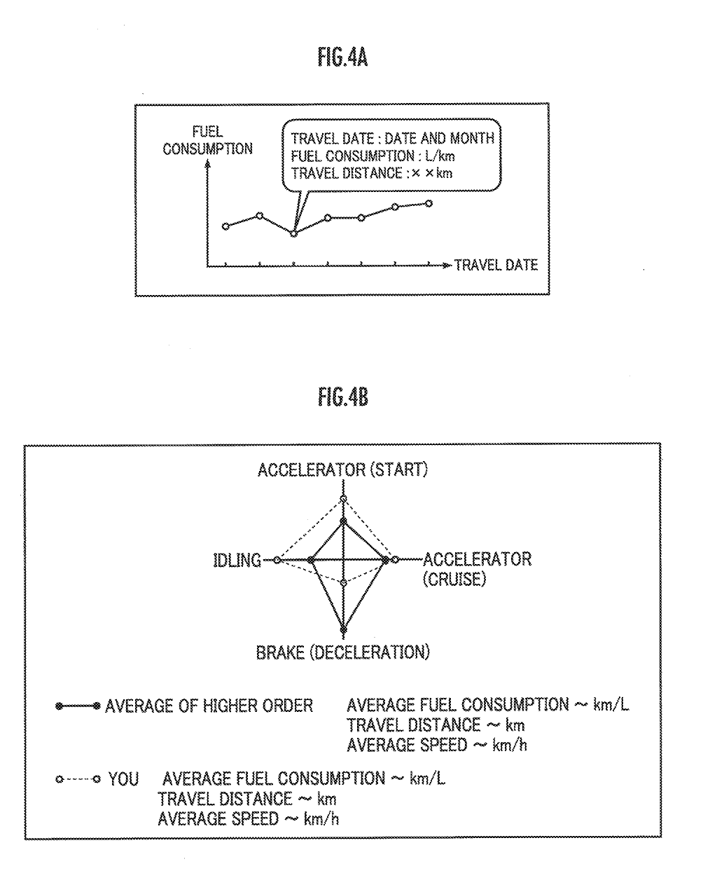

Arranged as such, for example, as is shown in FIG. 4A, a graph indicating a transition of the average fuel consumption per unit term of the vehicle is output and displayed on the display of the information processing terminal device 300.

In a state the image of FIG. 4A is output, one unit term (date and month, month, or the like) is designated among a plurality of unit terms through an input device such as a mouse-pointing device or the like at the information processing terminal device 300.

In response to the input of designating the unit term, as is shown in FIG. 4B, a radar chart indicating an average fuel consumption (dashed line) of the vehicle in the designated unit term and the average fuel consumption (solid line) of the reference vehicle in the designated unit term in each of the idling state (f=0), start acceleration state (f=1), deceleration state (f=2), and acceleration state (f=3), is output at the information processing terminal device 300. Moreover, a numerical value of the average fuel consumption, travelling distance, and average speed of each of the vehicle and the reference vehicle are also output.

In a state the image of FIG. 4B is output, each travelling state can be designated through the input device of the information processing terminal device 300.

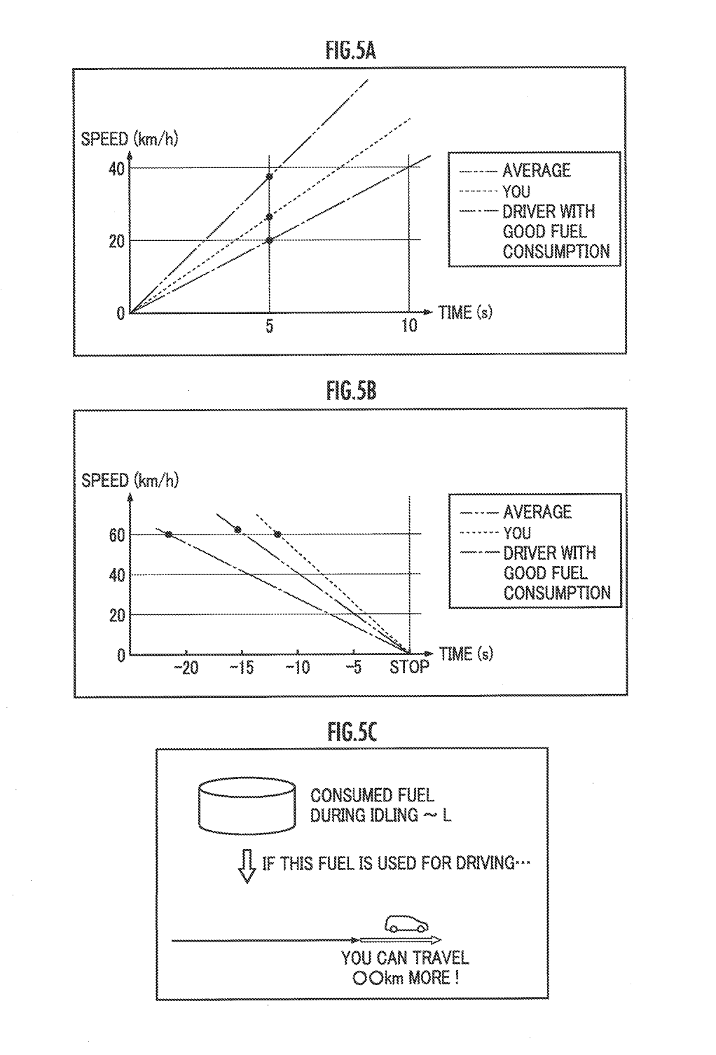

In response to the input of designating the start acceleration state (f=1) or the acceleration state (f=3), as is shown in FIG. 5A, a graph indicating an average acceleration manner in the designated unit term for each of the vehicle, the plurality of vehicles, and the reference vehicle in the start acceleration state (f=1) or the acceleration state (f=3), is output at the information processing terminal device 300. The inclination of the dashed line expresses the average acceleration α of the vehicle, the inclination of the two-dot chain line expresses the average acceleration α₀ of the plurality of vehicles, and the inclination of the one-dot chain line expresses the average acceleration α₀* of the reference vehicle.

In response to the input designating the deceleration state (f=2), as is shown in FIG. 5B, a graph indicating an average deceleration manner in the designated unit term for each of the vehicle, the plurality of vehicles, and the reference vehicle in the deceleration state (f=2), is output at the information processing terminal device 300.

The inclination of the dashed line expresses the average deceleration α of the vehicle, the inclination of the two-dot chain line expresses the average deceleration α₀ of the plurality of vehicles, and the inclination of the one-dot chain line expresses the average deceleration α₀* of the reference vehicle.

In addition, in response to the input designating the idling state (f=0), as is shown in FIG. 5C, an image showing a fuel consumption amount q in the designated unit term of the vehicle in the idling state (f=0) and an image showing the change of the fuel consumption of the vehicle in the designated unit term in a case it is assumed that this fuel is used for driving, are output to the information processing terminal device 300.

The images shown in each of FIGS. 4A, 4B, 5A, 5B, and 5C may be sequentially output, or may be displayed together at once. Moreover, the latest image may be output in place of the previous image, or the latest image may be output in addition to the previous image.

(Effect of the Vehicle Information Management System)

According to the vehicle information management system which exerts the function described above, it is able to make the driver of each vehicle recognize a reference driving information according to the acceleration α₀*(f) of the reference vehicle (reference driving index value) extracted from a plurality of vehicles based on the standard value fe₀(f) (refer to FIG. 5A, FIG. 5B etc.). By doing so, it is able to make the driver recognize the correlation between the standard value fe₀(f) and the reference acceleration α₀*(f) (reference driving index value), and use it as reference upon driving the vehicle himself/herself.

The standard value fe₀(f) is set fluidly according to the actual fuel consumption of each vehicle. Therefore, a situation in which the standard value fe₀(f), and thus the reference acceleration α₀*(f) (reference driving index value), is set to a value deviated from a travelling environment of each vehicle can be avoided. As a result, the improvement of usability of the reference driving information is attained.

For example, through the output image shown in FIG. 4B, it is able to make the user recognize that the average fuel consumption of the vehicle during deceleration (f=2) is higher (better) than that of the reference vehicle, while each average fuel consumption of the vehicle during each of the idling (f=0), start acceleration (f=1), and acceleration (f=3) is lower (worse) than that of the reference vehicle.

Furthermore, through the output image of FIG. 5A, it is able to make the user recognize that although the acceleration (inclination of the dashed line) of a vehicle driven by himself/herself is lower than an average acceleration (inclination of two-dot chain line) of a plurality of vehicles including other vehicles, it is higher than an average acceleration (inclination of one-dot chain line) of the reference vehicle (a model vehicle in view of fuel consumption improvement). By this, it is able to make the user recognize that a more gradual acceleration of the vehicle is preferable from the view point of improving the fuel consumption to the same level as the reference vehicle extracted according to the standard value.

Furthermore, through the output image of FIG. 5B, during deceleration travelling (f=2), it is able to make the user recognize that the deceleration (inclination of the dashed line) of a vehicle driven by himself/herself is higher than each of an average deceleration (inclination of two-dot chain line) of a plurality of vehicles including other vehicles and an average deceleration (inclination of one-dot chain line) of the reference vehicle. By this, it is able to make the user recognize that a more gradual deceleration of the vehicle is preferable from the view point of improving the fuel consumption.

Moreover, through the output image of FIG. 5C, it is able to make the user recognize that is it able to improve fuel consumption by shortening an accumulated time which is in the idling state (f=0).

### Another Embodiment of the Present Invention

In the embodiment described above, the “fuel consumption” of a vehicle has been considered. However, as another embodiment, as for vehicles which travel by converting electric power (for example, power stored in the installed battery) to propulsive force such as electric vehicles and hybrid vehicles or the like, “power consumption” in place of or in addition to fuel consumption may be considered. “Power consumption” means a travelling distance of a vehicle per unit of consumption amount of electric power. In such case, the power consumption is regarded to be “good” as the power consumption is higher, and “bad” as the power consumption is lower. Contrary to this, it is acceptable that “power consumption” is meant to be a power consumption amount per unit of travelling distance of the vehicle. In such case, the power consumption is “good” as the power consumption is lower, and the power consumption is “bad” as the power consumption is higher.

According to the vehicle information management system as the another embodiment, similar to the previous embodiment, it is able to make the user recognize the correlation between the standard value fe₀(f) and the reference driving index value through reference driving information having high usability, and use it as reference upon driving the vehicle himself/herself. For example, it is able to make the user recognize that a more gradual acceleration of the vehicle is preferable from the view point of improving the power consumption to the same level of the reference vehicle extracted according to the standard value (refer to FIG. 5A). Moreover, it is able to make the user recognize that a more gradual deceleration of the vehicle is preferable from the view point of improving the power consumption (refer to FIG. 5B).

In the previous embodiment, the acceleration of the vehicle was measured as the driving index value, as the another embodiment. However, as another embodiment, a manipulated variable of an accelerator, a manipulated variable (number of times) of a brake, idling time, an operation time of an air conditioner or the like, may be measured as the driving index value based on output signals or the like of sensors installed in the vehicle.

It is acceptable that the vehicle group as the target for calculating the standard value or the like is grouped and recognized according to a geographical range or road types or the like, in place of or in addition to the unit term. For example, in a unit term (date and month or the like), the standard value or the like may be calculated for each of the group of vehicles which travelled on an expressway and the group of vehicles which travelled on an ordinary road. Moreover, the standard value or the like may be calculated for each of the group of vehicles which travelled in mountainous areas (regions with many slopes) and the group of vehicles which travelled in plain areas (regions with less slopes).

### EXPLANATIONS OF REFERENCE NUMERALS

100 . . . vehicle information management server, 110 . . . first support arithmetic processing element, 120 . . . second support arithmetic processing element, 200 . . . vehicle information management device, 300 . . . information processing terminal device

1. A vehicle information management server comprising:
a first support arithmetic processing element configured to recognize a driving index value as an index of a driving manner and a fuel consumption or a power consumption of each of vehicles, based on communications with each of the vehicles, and then to recognize a standard value as a criteria for determining a level of the fuel consumption or power consumption of each of the vehicles according to the fuel consumption or power consumption of each of the vehicles; and
a second support arithmetic processing element configured to recognize a reference driving index value based on the driving index value of one or a plurality of reference vehicles extracted among the vehicles based on the standard value recognized by the first support arithmetic processing element, and then to make a predetermined information processing terminal device recognize and output a reference driving information related to the reference driving index value, based on communication with the predetermined information processing terminal device.

2. The vehicle information management server according to claim 1, wherein the first support arithmetic processing element is configured to recognize separately each of a different travelling states of each of the vehicles based on communication with each of the vehicles, and then to recognize the standard value for each of the different travelling states, and the second support arithmetic processing element is configured to recognize the reference driving index value for each of the different travelling states and to make the predetermined information processing terminal device recognize the reference driving index value.

3. The vehicle information management server according to claim 1, wherein the first support arithmetic processing element is configured to recognize as the standard value for a certain vehicle, an average fuel consumption or an average power consumption of the vehicles, or an average fuel consumption or an average power consumption of one vehicle group in which the certain vehicle belongs or of another vehicle group which is adjacent to the one vehicle group at a high fuel consumption side or a high power consumption side, or at a low fuel consumption side or a low power consumption side, among a plurality of vehicle groups defined by sectioning the vehicles according to a level of the fuel consumption or the power consumption.

4. The vehicle information management server according to claim 1, wherein the second support arithmetic processing element is configured to make the predetermined information processing terminal device to recognize and output, for a certain vehicle, the reference driving information related to the driving index value recognized by the first support arithmetic processing element in addition to the reference driving index value.

5. The vehicle information management server according to claim 1, wherein the first support arithmetic processing element is configured to recognize a position of the vehicle in time series in each cycle based on communication with the vehicle, and then to recognize a speed and acceleration-deceleration of the vehicle as the driving index value in the each cycle, based on the position of the vehicle in time series in each cycle.

6. A vehicle information management system comprising a vehicle information management device installed in a vehicle and a vehicle information management server,
the vehicle information management server comprising:
a first support arithmetic processing element configured to recognize for each of vehicles, a driving index value as an index of a driving manner and a fuel consumption or a power consumption of each of the vehicles based on communications with each of the vehicles, and then to recognize a standard value as a criteria for determining a level of the fuel consumption or power consumption of each vehicle according to the fuel consumption or power consumption of each of the vehicles; and
a second support arithmetic processing element configured to recognize a reference driving index value based on the driving index value of one or a plurality of reference vehicles extracted among the vehicles based on the standard value recognized by the first support arithmetic processing element, and then to make a predetermined information processing terminal device recognize and output a reference driving information related to the reference driving index value, based on communication with the predetermined information processing terminal device, and
wherein the vehicle information management device is configured to make the first support arithmetic processing element recognize the driving index value based on communication with the vehicle information management server.

7. A vehicle information management method performed by a computer comprising:
an arithmetic processing for recognizing a driving index value as an index of a driving manner and a fuel consumption or a power consumption of each of vehicles based on communications with each of the vehicles;
an arithmetic processing for recognizing a standard value as a criteria for determining a level of the fuel consumption or power consumption of each vehicle according to the fuel consumption or power consumption of each of the vehicles;
an arithmetic processing for recognizing a reference driving index value based on the driving index value of one or a plurality of reference vehicles extracted among the vehicles based on the standard value; and
an arithmetic processing for making a predetermined information processing terminal device recognize and output a reference driving information related to the reference driving index value, based on communication with the predetermined information processing terminal device.
